(19) United States
(12) Patent Application Publication
(10) Pub. No.: US 2026/0313702 A1
(43) Pub. Date: Oct. 8, 2026

(54) TECHNOLOGIES FOR PHYSICAL RANDOM ACCESS CHANNEL TRIGGERING AND UPLINK SYNCHRONIZATION FOR CANDIDATE CELLS

(71) Applicant: Apple Inc., Cupertino, CA (US)

(72) Inventors: Hong He, San Jose, CA (US); Chunhai Yao, Beijing (CN); Dawei Zhang, Saratoga, CA (US); Chunxuan Ye, San Diego, CA (US); Wei Zeng, Saratoga, CA (US); Jie Cui, San Jose, CA (US)

(73) Assignee: Apple Inc., Cupertino, CA (US)

(21) Appl. No.: 19/483,238

(22) PCT Filed: May 11, 2023
(86) PCT No.: PCT/CN2023/093544

§ 371 Date: Nov. 10, 2025

(51) Int. Cl. H04W 74/0833; H04B 17/318; H04W 36/00

(52) U.S. Cl. CPC H04W 74/0833; H04B 17/328; H04W 36/0072

(57) ABSTRACT

The present application relates to devices and components including apparatus, systems, and methods for physical random-access channel triggering and uplink synchronization for candidate cells in wireless networks.

### TECHNICAL FIELD

This application relates generally to wireless communication networks and, in particular, to technologies for physical random access channel (PRACH) triggering and uplink synchronization for candidate cells in said wireless networks.

### BACKGROUND

New mobile services that benefit from low-latency and high reliability performance (for example, ultra-reliable, low-latency communications (URLLC)) are emerging. While Third Generation Partnership Project (3GPP) 5^{th} Generation (5G) standards have been designed to address these services from the start, the evolution of 5G New Radio (NR), and subsequent generations, need to continuously enhance the mobility robustness performance for these challenging scenarios.

### BRIEF DESCRIPTION OF THE DRAWINGS

FIG. 1 illustrates a network environment in accordance with some embodiments.

FIG. 2 illustrates a configuration of a network environment in accordance with some embodiments.

FIG. 3 illustrates another configuration of a network environment in accordance with some embodiments.

FIG. 4 illustrates another configuration of a network environment in accordance with some embodiments.

FIG. 5 illustrates an operational flow/algorithmic structure in accordance with some embodiments.

FIG. 6 illustrates another operational flow/algorithmic structure in accordance with some embodiments.

FIG. 7 illustrates another operational flow/algorithmic structure in accordance with some embodiments.

FIG. 8 illustrates a user equipment in accordance with some embodiments.

FIG. 9 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and/or techniques in order to provide a thorough understanding of the various aspects of some embodiments. However, it will be apparent to those skilled in the art having the benefit of the present disclosure that the various aspects of the various aspects may be practiced in other examples that depart from these specific details. In certain instances, descriptions of well-known devices, circuits, and methods are omitted so as not to obscure the description of the various aspects with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), and/or digital signal processors (DSPs), that are configured to provide the described functionality. In some aspects, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these aspects, the combination of hardware elements and program code may be referred to as a particular type of circuitry.

The term “processor circuitry” as used herein refers to, is part of, or includes circuitry capable of sequentially and automatically carrying out a sequence of arithmetic or logical operations; or recording, storing, or transferring digital data. The term “processor circuitry” may refer an application processor; baseband processor; a central processing unit (CPU); a graphics processing unit; a single-core processor; a dual-core processor; a triple-core processor; a quad-core processor; or any other device capable of executing or otherwise operating computer-executable instructions, such as program code; software modules; or functional processes.

The term “interface circuitry” as used herein refers to, is part of, or includes circuitry that enables the exchange of information between two or more components or devices. The term “interface circuitry” may refer to one or more hardware interfaces; for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type of interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to computer, storage, or network resources provided by physical hardware element(s). A “virtualized resource” may refer to computer, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects or services, accessible through a server where such system resources reside on a single host or multiple hosts and are clearly identifiable.

The terms “multi,” “multiple,” “plurality,” and the like as used herein refer to more than one item, instance, or event.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element or a data element that contains content. An information element may include one or more additional information elements.

MIMO and mobility enhancements may be developed to improve operation of wireless networks compatible with 3GPP standards. These enhancements include consideration of using two timing advance (TA) values for uplink communication for multi-downlink control information (DCI), multi-transmit-receive point (mTRP) operation. These enhancements further include considerations of mechanisms and procedures of layer 1 (L1)/layer 2 (L2)-based intra-cell mobility (LTM) for mobility latency reduction. Embodiments of the present disclosure address various issues that may occur with respect to these enhancements.

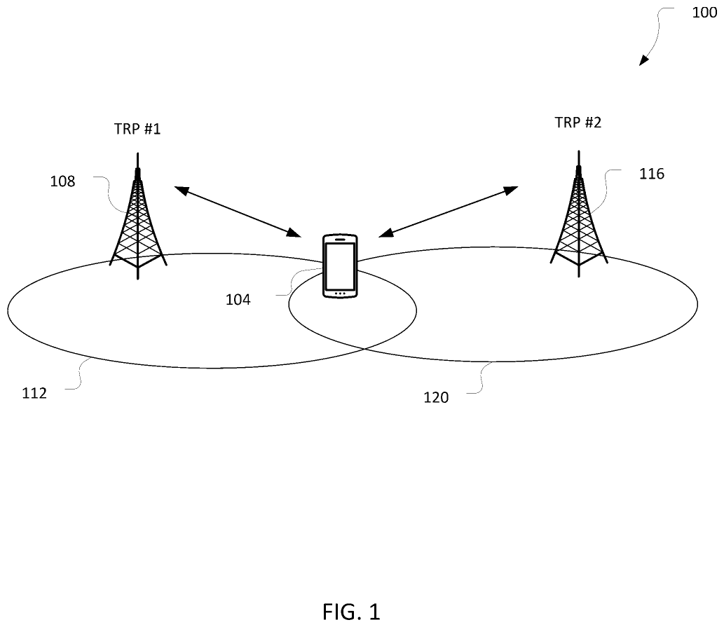

FIG. 1 illustrates a network environment 100 in accordance with some embodiments. The network environment 100 may include a UE 104 communicatively coupled with a first TRP 108 that provides a serving cell 112. The serving cell 112 may provide an air interface compatible with 3GPP TSs, such as those that define 5G NR or later system standards.

The first TRP 108 may correspond to, or be coupled with, a base station. The base station may also be referred to as an eNB, gNB, an ng-NB, etc. The base station may provide the UE 104 access to other networks, for example, a core network, a data network, etc.

The network environment 100 may further include a second TRP 116 that provides an additional cell 120. The second TRP 116 may provide an access technology similar to that described above with respect to the first TRP 108. In some embodiments, the additional cell 120 may be associated with a same physical cell identifier (PCI) as the serving cell 112. These embodiments may be referred to as intra-cell mTRP deployment. In other embodiments, the additional cell 120 may be associated with a different PCI than the serving cell 112.

Operations described herein with respect to a cell (for example, the serving cell 112 or additional cell 120) may be performed by a corresponding TRP or base station (for example, TRP 108 or TRP 116, respectively), and vice versa.

In some embodiments, the UE 104 may seek to perform a contention-based random-access (CBRA) procedure to obtain a TA value for uplink communications with the additional cell 120. To obtain the TA value, the UE 104 may select a PRACH resource, for example, a random-access (RA) preamble, from a pool of shared PRACH resources. The UE 104 may transmit the RA preamble to the second TRP 116, which measures the transmission to obtain a TA value that is then provided to the first TRP 108. The first TRP 108 may provide the TA value to the UE 104 in a RA response message of the serving cell 112.

The UE 104 may select the PRACH resources based on measurements of detected synchronization signal blocks (SSBs). However, in a typical intra-cell mTRP deployment, a UE may not be able to determine with which TRP a detected SSB is associated. Correspondingly, for the CBRA procedure in a typical intra-cell mTRP deployment, a UE may not be able to properly select PRACH resources toward a second TRP to obtain the second TA value. Thus, various embodiments of the present disclosure describe the serving cell 112 configuring groups of resources in a manner that supports CBRA procedures in an intra-cell mTRP deployment.

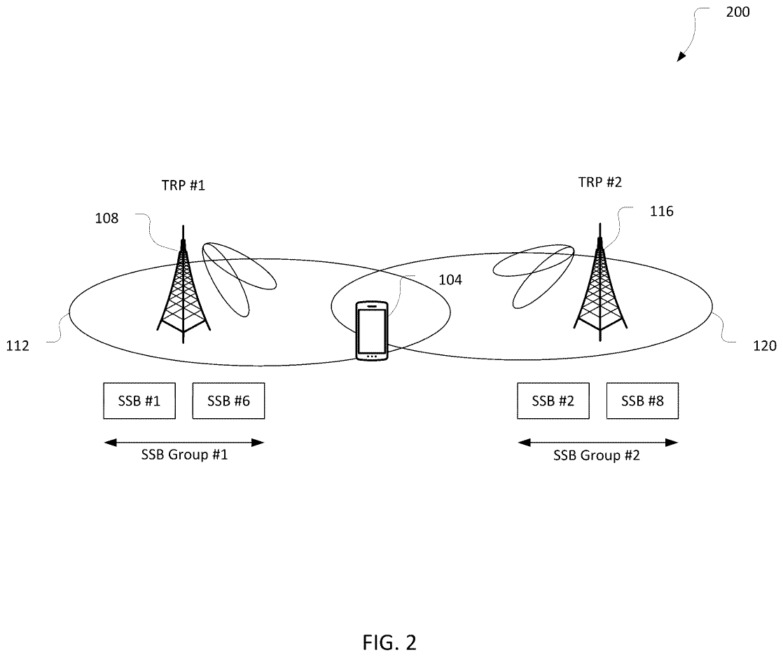

FIG. 2 illustrates a configuration 200 of the network environment 100 to facilitate CBRA procedures to obtain a TA value for the second TRP 116 in an intra-cell mTRP deployment in accordance with some embodiments.

The serving cell 112 may transmit a system information block 1 (SIB1) message with an SSB-positions-in-burst (ssb-PositionsinBurst) field that has a bitmap to indicate which SSBs are transmitted by TRPs associated with the same PCI, for example, the first TRP 108 and the second TRP 116. The SSBs indicated by ssb-PositionsInBurst field may be divided into two different groups. For example, as shown, SSB group #1 may include SSBs #1 and #6, while SSB group #2 includes SSBs #2 and #8.

The SSB grouping configuration may be signaled by the serving cell 112. In some embodiments, the serving cell 112 may provide the SSB grouping configuration through SIB information. In other embodiments, the serving cell 112 may provide the SSB grouping configuration through a UE-dedicated RRC message, which may be possible given that the UE 104 is in an RRC connected state with respect to the serving cell 112.

For an intra-cell CBRA procedure, the UE 104 may select a PRACH resource associated with an SSB in a SSB group ‘k’ that is different from an SSB group that includes an SSB associated with the active TCI-state. For example, if the serving cell 112 previously activated a TCI state associated with SSB #6, the UE 104 may determine that the group that includes SSB #6, SSB group #1, is associated with the serving cell 112. Thus, the UE 104 may select an SSB from the other group, SSB group #2, to serve as a basis for the PRACH resource selection. The UE 104 may select the SSB of SSB group #2 that is detected with the highest signal quality, for example, a highest reference signal receive power (RSRP). The UE 104 may then use the PRACH resource associated with that SSB for transmission toward the second TRP 116.

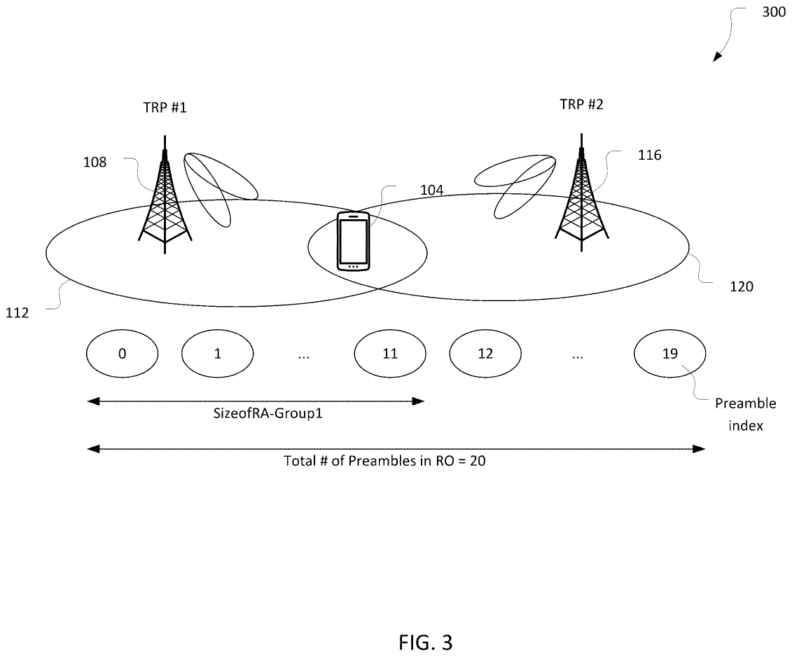

FIG. 3 illustrates another configuration 300 of the network environment 100 to facilitate CBRA procedures in an intra-cell mTRP deployment in accordance with some embodiments. In these embodiments, the serving cell 112 may configure the UE 104 with two groups of PRACH resources, for example, group 1 and group 2.

In some embodiments, the serving cell 112 may transmit a parameter that defines a size of one of the groups. For example, the serving cell 112 may transmit a size of RA group 1 (sizeofRA-Group1) parameter for each PRACH occasion. The RA preambles of group 1 may then be determined as the preambles from 0 to sizeofRA-Group1. The remaining RA preambles may be considered to be in group 2.

With reference to FIG. 3, the serving cell 112 may provide the UE 104 with a sizeofRA-Group1 that is set to 12. If the PRACH occasion is configured with 20 RA preambles, the UE 104 may determine group 1 includes the first 12 preambles (preambles 0-11) and group 2 includes the remaining preambles (preambles 12-19).

The serving cell 112 may provide explicit signaling, for example, RRC signaling, as to which PRACH group the UE 104 is to use for a CBRA procedure to obtain the second TA value.

While some embodiments describe configuring two groups of resources for two TRPs, other embodiments may include additional groups of resources for additional TRPs.

A second issue that may be addressed by embodiments of the present disclosure relates to inter-cell, cross-TRP contention-free random-access (CFRA) procedures for LTM. In particular, embodiments describe how to select a pathloss reference signal (PL RS) to determine a transmission power for a PRACH triggered by a PDCCH order from a first cell toward a second cell.

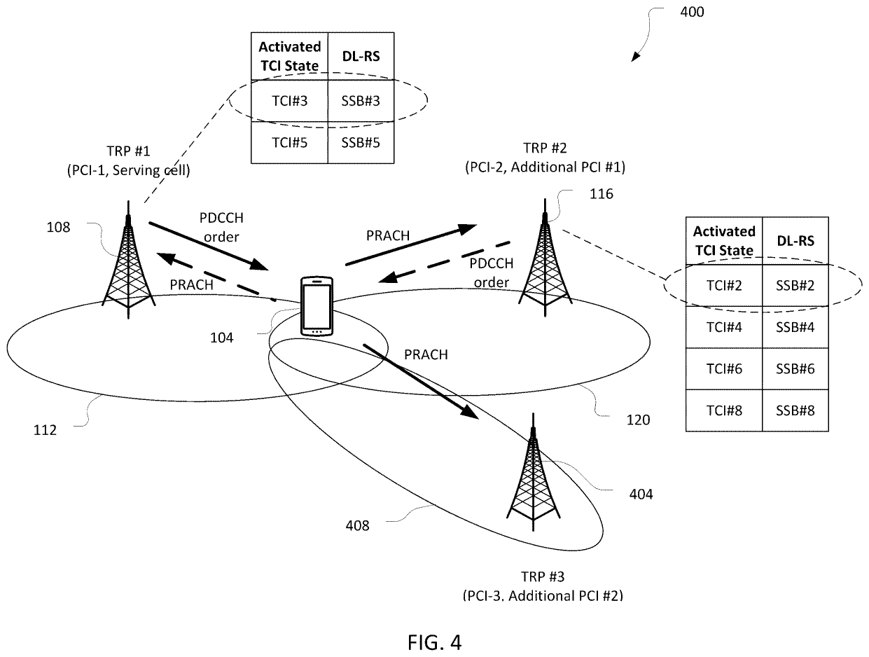

FIG. 4 illustrates another configuration 400 of the network environment 100 to describe cross-TRP triggered PRACH procedures in accordance with some embodiments.

In configuration 400, the first TRP 108 and the second TRP 116 may have different PCIs, for example, the first TRP 108 may be associated with PCI-1, while the second TRP 116 may be associated with PCI-2. Configuration 400 may further include a third TRP (TRP #3) 404 that provides another additional cell 408. The third TRP 404 may be associated with PCI-3. The UE 104 may be configured with the PCI of the second TRP 116 as a first additional PCI (additional PCI #1) for purposes of inter-cell mobility and may be configured with the PCI of the third TRP 404 as a second additional PCI (additional PCI #2).

FIG. 400 shows the serving cell 112 and the additional cell 120 each having at least one activated TCI state. For example, the UE 104 may receive a MAC CE that activates, for the serving cell 112, two TCI states (#3, #5) that have two SSBs (#3, #5) configured as their respective DL RSs. The UE 104 may also receive a MAC CE that activates, for the additional cell 120, four TCI states (#2, #4, #6, and #8) that have four SSBs (#2, #4, #6, and #8) configured as their respective DL RSs. The activated TCI states of the serving cell 112 may be associated with a first control resource set (CORESET) pool index (for example, CORESETpoolIndex=0), while the activated TCI states of the additional cell 120 may be associated with a second CORESET pool index (for example, CORESETpoolIndex=1). The additional cell 408 may not have any activated TCI states.

In configuration 400, a CFRA procedure may be initiated by the first TRP 108 transmitting a PDCCH order to the UE 104. The PDCCH order may indicate a PRACH resource, which the UE 104 may send to the second TRP 116 (or third TRP 404) in a PRACH message. A TA value may be determined by the second TRP 116 (or third TRP 404) and provided to the UE 104 in a manner similar to that described above with respect to the CBRA procedure. In some embodiments, instead of the first TRP 108 transmitting the PDDCH order and the UE 104 transmitting the PRACH message to the second TRP 116 (or third TRP 404), the second TRP 116 transmits the PDCCH order to the UE 104 and the UE 104 sends the PRACH message to the first TRP 108 as shown by the messages with dotted lines in FIG. 4.

The UE may select a PL RS for calculating a pathloss and spatial filter for the PRACH message (either toward the serving cell 112, the additional cell 120, or the additional cell 408) based on one or more of the following options.

In a first option, the UE 104 may use the SSB indicated in the DCI of the PDCCH order as the PL RS to calculate a pathloss and spatial filter for the PRACH message. For example, if the PDCCH order indicates SSB #9, the UE 104 will use SSB #9 as the PL RS for power control and for spatial filter determination for the PRACH message.

In a second option, a DL RS of an indicated TCI state associated with a corresponding CORESET pool index value may be used as the PL RS for calculating the pathloss and the spatial filter. This may be based on which TRP triggers the CFRA PRACH and whether an additional cell includes an activated TCI state. Two cases are described below.

A first case may correspond to a situation in which the CFRA PRACH is being triggered by the serving cell 112 toward the additional cell 120, which includes at least one activated TCI state as described above. In this case, the DL RS of the indicated TCI state associated with a CORESET pool index (CORESETpoolIndex)=1 may be used as the PL RS for PRACH power control and spatial filter determination. For example, a TCI field in DCI format for PCI-2 (for example, the additional cell 120), may indicate TCI #2. Thus, in this situation, the UE 104 may use SSB #2 for power control and spatial filter determination to transmit the PRACH message toward the second TRP 116. A second case may correspond to a situation in which the CFRA PRACH is being triggered by the additional cell 120, which has at least one activated TCI state as described above, toward the serving cell 112. In this case, the DL RS of the indicated TCI state associated with CORESETpoolIndex=0 may be used as the PL RS for PRACH power control and spatial filter determination. For example, a TCI field in DCI format for PCI-1, may indicate TCI #3. Thus, in this situation, the UE 104 may use SSB #3 for power control and spatial filter determination to transmit the PRACH toward the first TRP 108.

A third option may be used if the CFRA PRACH is triggered by the serving cell 112 towards an additional PCI that does not have any activated TCI states, for example, toward additional cell 408. In this option, the UE 104 may use the SSB indicated in the DCI of the PDCCH order as the PL RS to calculate the PRACH power control and spatial filter determination if the indicated SSB has been reported by the UE 104 in a recent L1-RSRP report. For example, if the PDCCH order indicates SSB #9, the UE 104 will use SSB #9 as the PL RS for power control and for spatial filter determination for PRACH message if the UE 104 has included SB #9 in a recent L1-RSRP reporting.

In some embodiments, an L1-RSRP report may be determined to be recent if it is within, for example, an X ms window. In various embodiments, the size of the window may be predefined in, for example, a 3GPP TS, or configured by the network using dedicated RRC signaling, for example.

Providing the additional consideration of the SSB being from a recent L1-RSRP report may ensure that the SSB has been recently detected by the UE 104. This may, in turn, improve the chances that the SSB provides a desired basis for transmitting the PRACH message.

A third issue that may be addressed by embodiments relates to PRACH procedures without RA responses. In a conventional RACH procedure, a UE may determine whether to retransmit an RA preamble based on whether an RA response is received within a predetermined window. If the PRACH procedure does not include an RA response, it may be beneficial to repeatedly transmit the PRACH message for LTM operation to enhance the PRACH coverage toward a candidate cell. Embodiments of the present disclosure describe approaches that may be considered to enable PRACH repetition for PDCCH-order CFRA procedures in LTM. The UE 104 may determine a repetition number for transmitting the PRACH message in accordance with one or more of the following options.

In a first option, a repetition-number field may be included within a PDCCH order to indicate a number of times a triggered PRACH message is to be transmitted. The repetition-number field may be added to a DCI format 1_0 that is used for the PDCCH order. In some embodiments, one or more reserved bits in an existing DCI format 1_0 may be repurposed as the repetition-number field. The repetition-number field may be, for example, a 2-bit field that is used to indicate one of four predefined values, for example, {1, 2, 4, 8}repetitions. In other embodiments, other size fields/predefined values may be used.

In a second option, ‘N’ repetition numbers maybe predefined in, for example, a 3GPP specification. For example, N=4 with repetition numbers {1, 2, 4, 8}. In some embodiments, the UE 104 may be provided with a mapping between a repetition number and a control channel element (CCE) aggregation level (AL) used to transmit the PDCCH order. The mapping may be predefined in, for example, a 3GPP specification, or signaled by the network.

In some embodiments, a mapping between CCE ALs and repetition numbers may be similar to that defined in Table 1.

TABLE 1

| CCE Aggregation Level | Repetition Number of PRACH |
|---|---|
| 1 | 1 |
| 2 | 2 |
| 4 | 4 |
| 8 | 8 |
| 16 | 8 |

As shown in Table 1, some CCE ALs (for example 1, 2, and 4) may be one-to-one mapped to a repetition number, and some CCE ALs (for example, 8 and 16) may be n-to-one mapped to a repetition number, where n=2 in Table 1.

The UE 104 may determine the repetition number for a PRACH message based on the associated CCE aggregation level of the detected PDCCH order DCI 1_0. For example, assuming a PDCCH order DCI is detected with CCE AL=4, then the PRACH triggered by the PDCCH order DCI is transmitted with 4 repetitions.

The repetition count, as used herein, may refer to a number of times the PRACH message is transmitted in total or the number of times the PRACH message is retransmitted after an original transmission.

A fourth issue that may be addressed by embodiments of the present disclosure relate to the serving cell 112 determining when to trigger a TA update for a candidate cell, for example, additional cell 120.

Various embodiments describe the serving cell 112 determining when to trigger a TA re-acquisition for the additional cell 120 in accordance with one or more of the following options.

In a first option, after the additional cell 120 forwards the TA value to the serving cell 112, the additional cell 120 starts a time-alignment timer (TAT). When the TAT expires, the additional cell 120 sends an indication to the serving cell 112 to trigger the TA reacquisition. The serving cell 112 may then trigger the TA reacquisition by sending the PDCCH order to the UE 104.

In a second option, when the additional cell 120 forwards the TA value to the serving cell 112 it may also include a TAT configuration. The TA value/TAT configuration may be transmitted from the additional cell 120 to the serving cell 112 using Xn signaling (for example, signaling over an Xn interface between the two TRPs). The TA value may be in the same message as the TAT configuration or in separate messages. The serving cell 112 may then set the TAT based on the TAT configuration. When the TAT expires, the serving cell 112 may trigger the TA re-acquisition by transmitting the PDCCH order to the UE 104.

In a third option, the candidate cell 120 may transmit the TAT configuration to the serving cell 112 similar to that described in the second option. However, in the third option, the serving cell 112 may provide the TAT configuration to the UE 104. The TAT configuration may be provided to the UE 104 for each candidate cell during an LTM preparation phase. The UE 104 may then set a TAT based on the TAT configuration. When the TAT expires, the UE 104 may inform the serving cell 112 to trigger the TA reacquisition. To facilitate this UE-based triggering, the UE 104 may use a dedicated PUCCH resource to inform the serving cell 112 that it is to trigger the TA reacquisition. The dedicated PUCCH resource may be configured to the UE 104 for dedicated SR transmissions. Upon receiving the trigger from the UE 104, the serving cell 112 may transmit the PDCCH order to trigger the TA reacquisition.

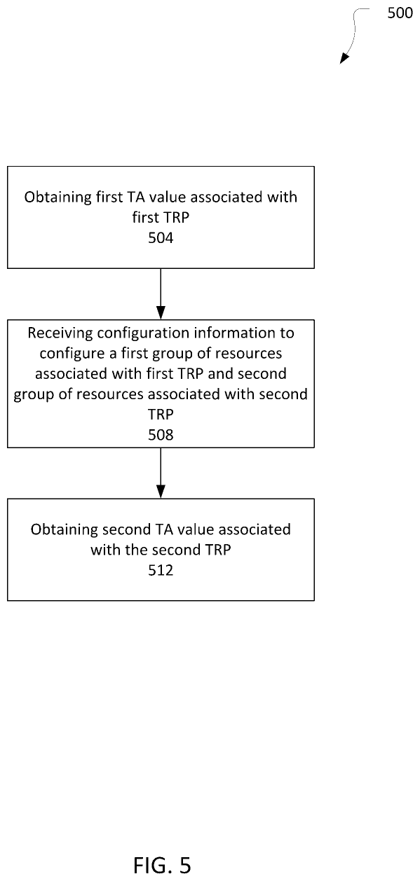

FIG. 5 illustrates an operational flow/algorithmic structure 500 in accordance with some embodiments. The operational flow/algorithmic structure 500 may be implemented by a UE such as, for example, UE 104, UE 800, or components therein, for example, processors 804.

The operational flow/algorithmic structure 500 may include, at 504, obtaining a first TA value associated with a first TRP. The first TRP may provide a serving cell having a first PCI. The first TA value may be obtained by performing a PRACH procedure with the serving cell or by the serving cell transmitting a TA update in a MAC CE.

The operational flow/algorithmic structure 500 may further include, at 508, receiving configuration information to configure a first group of resources associated with the first TRP and a second group of resources associated with a second TRP. The second TRP may provide an additional cell that also has the first PCI. The resources may be SSBs or PRACH resources (for example, RA preambles). The configuration information may be received from the serving cell in system information (for example, a SIB) or in RRC signaling. The RRC signaling may be UE-dedicated.

The operational flow/algorithmic structure 500 may further include, at 512, obtaining a second TA value associated with the second TRP. The second TA value may be obtained using a resource from the second group of resources.

If the resources are SSBs, the UE may determine which SSB group includes an SSB associated with an active TCI state and then select an SSB from the other SSB group. The UE may select the SSB from the other SSB group that has the highest relative RSRP. The UE may then select a PRACH resource associated with the selected SSB. The UE may perform an intra-cell CBRA procedure using the selected PRACH resource to obtain the second TA value.

If the resources are PRACH resources, the UE may determine which RA preambles are in the first group and which RA preambles are in the second group based on a group-size parameter. The group-sized parameter may provide an indication of how many RA preambles, for example, the group-sized parameter may indicate the first group includes N preambles. The UE may then determine the first N RA preambles of the total RA preambles in a PRACH resource occasion are in the first group and the remaining RA preambles are in the second group. The serving cell may then provide an indication of whether to use the first group of RA preambles or the second group of RA preambles to obtain the second TA value. The UE may select an RA preamble from the indicated group and perform an intra-cell CBRA procedure using the selected PRACH resource to obtain the second TA value.

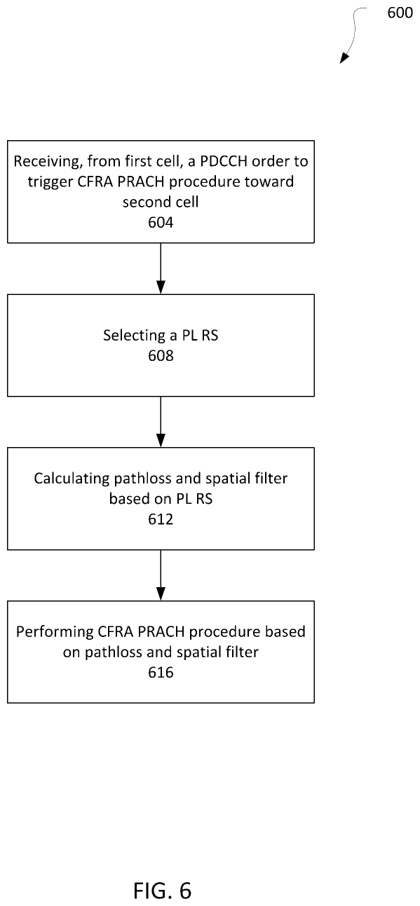

FIG. 6 illustrates an operational flow/algorithmic structure 600 in accordance with some embodiments. The operational flow/algorithmic structure 600 may be implemented by a UE such as, for example, UE 104, UE 800, or components therein, for example, processors 804.

The operational flow/algorithmic structure 600 may include, at 604, receiving a PDCCH order to trigger a CFRA PRACH procedure. The PDCCH order may be received from a first cell and trigger the CFRA PRACH procedure toward a second cell. In some embodiments, the first cell may be a serving cell and the second cell may an additional cell. In other embodiments, the first cell may be the additional cell and the second cell may be the serving cell.

The operational flow/algorithmic structure 600 may further include, at 608, selecting a PL RS.

In some embodiments, the PDCCH order may include DCI that indicates an SSB and the UE may select the SSB as the PL RS. If the first cell is the serving cell and the second cell is an additional cell that does not have an activated TCI state, in some embodiments, the UE may determine whether the SSB indicated in the PDCCH order was included in an L1-RSRP report transmitted by the UE no greater than a threshold period of time before receiving the PDCCH order. The threshold period may be predefined or configured by the network. If the SSB was in the L1-RSRP report, the UE may use the SSB as the PL RS.

If the first cell is the serving cell and the second cell is an additional cell that has an activated TCI state, the UE may identify a DL RS of a TCI state associated with CORESET pool index equal to 1 and use that DL RS as the PL RS.

If the first cell is the additional cell that has an activated TCI state and the second cell is the serving cell, the UE may identify a DL RS of a TCI state associated with CORESET pool index equal to 0 and use that DL RS as the PL RS.

In the event a DL RS is used, it may be an SSB or a CSI-RS.

The operational flow/algorithmic structure 600 may further include, at 612, calculating a pathloss and spatial filter based on the selected PL RS.

The operational flow/algorithmic structure 600 may further include, at 616, performing the CFRA PRACH procedure based on the pathloss and spatial filter. The CFRA PRACH procedure may include transmitting a PRACH message based on the determined pathloss and spatial filter.

In some embodiments, the PRACH message may be transmitted a number of times based on a repetition number. The repetition number may be determined based on the PDCCH order. For example, the PDCCH order may include DCI with a repetition number field that indicates the repetition number. In other embodiments, the repetition number may be associated with a CCE AL used to transmit the PDCCH order. The UE may determine the CCE AL based on decoding the PDCCH order and determine the associated repetition number. The mapping between the CCE AL and the repetition number may be predefined in, for example, a 3GPP TS, or configured by a network.

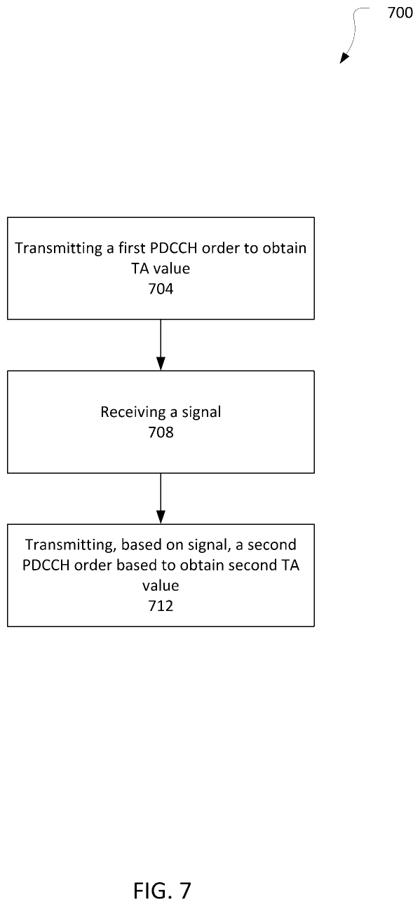

FIG. 7 illustrates an operational flow/algorithmic structure 700 in accordance with some embodiments. The operational flow/algorithmic structure 700 may be implemented by a network node that provides a serving cell such as, for example, the first TRP 108, a base station coupled with the TRP 108, network node 900 or components therein, for example, processors 904.

The operational flow/algorithmic structure 700 may include, at 704, transmitting a first PDCCH order to obtain a TA value. The PDCCH order may be transmitted to a UE to trigger a PRACH procedure toward an additional cell. The TA value may be received from the additional cell based on the PRACH procedure.

The operational flow/algorithmic structure 700 may further include, at 708, receiving a signal from the UE or the additional cell.

In some embodiments, the signal may be from the additional cell and include an indication that a TAT has expired. In these embodiments, the additional cell may start the TAT upon receiving the PRACH message resulting from the triggered PRACH procedure.

In some embodiments, the signal may be from the additional cell and include a TAT configuration. In these embodiments, the serving cell may start the TAT upon receiving the TAT configuration.

In some embodiments, the signal may be from the UE. In these embodiments, the serving cell may receive a TAT configuration from the additional cell based on the additional cell receiving the PRACH message resulting from the triggered PRACH procedure. The serving cell may then forward the TAT configuration to the UE. The UE may start the TAT upon receiving the TAT configuration and send the signal to the serving cell upon expiration of the TAT.

The operational flow/algorithmic structure 700 may further include, at 712, transmitting a second PDCCH order to obtain a second TA value. The second PDCCH order may be to the additional cell and the second TA value may represent an updated TA value with respect to the first TA value. The second PDCCH order may be directly based on the signal, for example, the signal is an indication that the serving cell should trigger the second PDCCH order based on expiration of the TAT at the additional cell or the UE. Alternatively, the second PDCCH order may be indirectly based on the signal, for example, the signal includes the TAT configuration, which the serving cell uses to start the TAT timer and uses the expiration of the TAT timer as the indication to trigger the second PDCCH order.

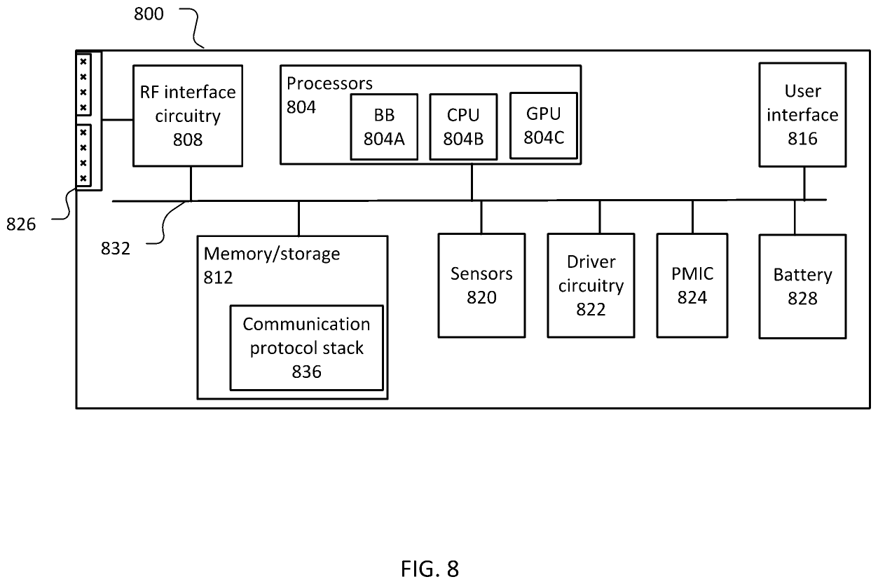

FIG. 8 illustrates a UE 800 in accordance with some embodiments. The UE 800 may be similar to and substantially interchangeable with UE 104 of FIG. 1.

The UE 800 may be any mobile or non-mobile computing device, such as, for example, a mobile phone, computer, tablet, XR device, glasses, industrial wireless sensor (for example, microphone, carbon dioxide sensor, pressure sensor, humidity sensor, thermometer, motion sensor, accelerometer, laser scanner, fluid level sensor, inventory sensor, electric voltage/current meter, or actuator), video surveillance/monitoring device (for example, camera or video camera), wearable device (for example, a smart watch), or Internet-of-things device.

The UE 800 may include processors 804, RF interface circuitry 808, memory/storage 812, user interface 816, sensors 820, driver circuitry 822, power management integrated circuit (PMIC) 824, antenna structure 826, and battery 828. The components of the UE 800 may be implemented as integrated circuits (ICs), portions thereof, discrete electronic devices, or other modules, logic, hardware, software, firmware, or a combination thereof. The block diagram of FIG. 8 is intended to show a high-level view of some of the components of the UE 800. However, some of the components shown may be omitted, additional components may be present, and different arrangement of the components shown may occur in other implementations.

The components of the UE 800 may be coupled with various other components over one or more interconnects 832, which may represent any type of interface, input/output, bus (local, system, or expansion), transmission line, trace, or optical connection that allows various circuit components (on common or different chips or chipsets) to interact with one another.

The processors 804 may include processor circuitry such as, for example, baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812.

In some embodiments, the baseband processor circuitry 804A may access a communication protocol stack 836 in the memory/storage 812 to communicate over a 3GPP compatible network. In general, the baseband processor circuitry 804A may access the communication protocol stack 836 to: perform user plane functions at a PHY layer, MAC layer, RLC sublayer, PDCP sublayer, SDAP sublayer, and upper layer; and perform control plane functions at a PHY layer, MAC layer, RLC sublayer, PDCP sublayer, RRC layer, and a NAS layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based cyclic prefix OFDM (CP-OFDM) in the uplink or downlink, and discrete Fourier transform spread OFDM (DFT-S-OFDM) in the uplink.

The memory/storage 812 may include one or more non-transitory, computer-readable media that includes instructions (for example, communication protocol stack 836) that may be executed by one or more of the processors 804 to cause the UE 800 to perform PRACH operations as described herein. For example, the processors 804 may cause the UE to perform the operational flow/algorithmic structure 500 or 600, or any other method or process described herein.

The memory/storage 812 include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 808 may include transceiver circuitry and radio frequency front module (RFEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna structure 826 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna structure 826.

In various embodiments, the RF interface circuitry 808 may be configured to transmit/receive signals in a manner compatible with NR access technologies.

The antenna structure 826 may include antenna elements to convert electrical signals into radio waves to travel through the air and to convert received radio waves into electrical signals. The antenna elements may be arranged into one or more antenna panels. The antenna structure 826 may have antenna panels that are omnidirectional, directional, or a combination thereof to enable beamforming and multiple input, multiple output communications. The antenna structure 826 may include microstrip antennas, printed antennas fabricated on the surface of one or more printed circuit boards, patch antennas, or phased array antennas. The antenna structure 826 may have one or more panels designed for specific frequency bands including bands in FR1 or FR2.

The user interface 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various I/O devices that may be present within, or connected to, the UE 800. For example, the driver circuitry 822 may include circuitry to facilitate coupling of a UICC (for example, UICC 88) to the UE 800. For additional examples, driver circuitry 822 may include a display driver to control and allow access to a display device, a touchscreen driver to control and allow access to a touchscreen interface, sensor drivers to obtain sensor readings of sensors 820 and control and allow access to sensors 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800 including DRX as discussed herein.

A battery 828 may power the UE 800, although in some examples the UE 800 may be mounted deployed in a fixed location, and may have a power supply coupled to an electrical grid. The battery 828 may be a lithium ion battery, a metal-air battery, such as a zinc-air battery, an aluminum-air battery, a lithium-air battery, and the like. In some implementations, such as in vehicle-based applications, the battery 828 may be a typical lead-acid automotive battery.

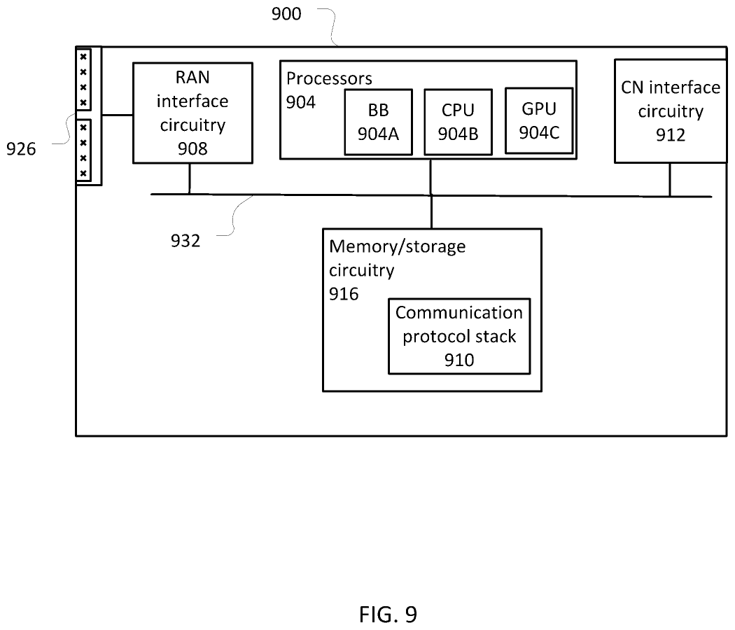

FIG. 9 illustrates a network node 900 in accordance with some embodiments. The network node 900 may be similar to and substantially interchangeable with TRPs 108, 116, or 404, or a base station coupled thereto.

The network node 900 may include processors 904, RF interface circuitry 908 (if implemented as an access node), core network (CN) interface circuitry 912, memory/storage 916, and antenna structure 926.

The components of the network node 900 may be coupled with various other components over one or more interconnects 932.

The processors 904, RF interface circuitry 908, memory/storage 916 (including communication protocol stack 910), antenna structure 926, and interconnects 932 may be similar to like-named elements shown and described with respect to FIG. 8.

The memory/storage 916 may include one or more non-transitory, computer-readable media that includes instructions (for example, communication protocol stack 910) that may be executed by one or more of the processors 904 to cause the network node 900 to perform PRACH operations as described herein. For example, the processors 904 may cause the network node 900 to perform operational flow/algorithmic structure 700, or any other method or process described herein.

The CN interface circuitry 912 may provide connectivity to a core network, for example, a 5th Generation Core network (5GC) using a 5GC-compatible network interface protocol such as carrier Ethernet protocols, or some other suitable protocol. Network connectivity may be provided to/from the network node 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

In some embodiments, the network node 900 may be coupled with transmit receive points (TRPs) using the antenna structure 926, CN interface circuitry, or other interface circuitry.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more aspects, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary aspects are provided.

Example 1 includes a method of operating a user equipment (UE), the method comprising: obtaining a first timing advance (TA) value associated with a first transmit-receive point (TRP) of a serving cell; receiving, from the serving cell, configuration information to configure a first group of resources associated with the first TRP and a second group of resources associated with a second TRP; and obtaining a second TA value associated with the second TRP using a resource from the second group of resources.

Example 2 includes a method of example 1 or some other example herein, wherein the first group of resources comprises a first synchronization signal block (SSB) and the second group of resources comprises a second SSB.

Example 3 includes a method of example 2 or some other example herein, the method further comprises: selecting the second SSB as the resource for obtaining the second TA value based on the first SSB being associated with an active transmission configuration indicator (TCI) state; and selecting a physical random access channel (PRACH) resource associated with the second SSB; and obtaining the second TA value by performing an intra-cell contention-based random-access (CBRA) procedure using the PRACH resource.

Example 4 includes a method of example 3 or some other example herein, wherein the second group of resources comprises a plurality of SSBs and the method further comprises: determining reference signal receive power (RSRP) values associated with the plurality of SSBs; and selecting the second SSB as the resource for obtaining the second TA value based on the RSRP values.

Example 5 includes a method of example 1 or some other example herein, wherein the first group of resources comprises a first random-access preamble and the second group of resources comprises a second random-access preamble.

Example 6 includes a method of example 1 or some other example herein, wherein the configuration information is to configure a plurality of random-access (RA) preambles, the configuration information includes a group-size parameter, and the method further comprises: determining, based on the group-size parameter, the first group of resources includes one or more first RA preambles of the plurality of RA preambles and the second group of resources includes one or more second RA preambles of the plurality of RA preambles.

Example 7 includes a method of example 6 or some other example herein, further comprising: receiving, from the serving cell, an indication of the second group of resources; selecting the resource from the second group of resources based on the indication; and obtaining the second TA value using the resource based on said selecting the resource.

Example 8 includes a method of any one of examples 1-7, further comprising: receiving the configuration information in a system information block (SIB) or in radio resource control (RRC) signaling.

Example 9 includes a method to be implemented by a user equipment (UE), the method comprising: receiving, from a first cell, a physical downlink control channel (PDCCH) order to trigger a contention-free random-access (CFRA) physical random-access channel (PRACH) procedure toward a second cell; selecting, based on the PDCCH order, a pathloss (PL) reference signal (RS); calculating a pathloss and spatial filter based on the PL RS; and performing the CFRA PRACH procedure based on the pathloss and the spatial filter.

Example 10 includes the method of example 9 or some other example herein, wherein the PDCCH order comprises downlink control information that indicates a synchronization signal block (SSB) and the method further comprises: using the SSB as the PL RS.

Example 11 includes the method of example 10 or some other example herein, wherein the first cell is a serving cell, the second cell is an additional cell that does not have an activated transmission configuration indicator (TCI) state, and the method further comprises: determining the SSB was included in a layer 1—reference signal receive power (RSRP) report transmitted by the UE no greater than a threshold period of time before receiving the PDCCH order; and using the SSB as the PL RS based on said determining.

Example 12 includes the method of example 9 or some other example herein, wherein the first cell is a serving cell of the UE, the second cell is an additional cell that has at least one activated transmission configuration indicator (TCI) state, and the method further comprises: identifying a downlink (DL) reference signal (RS) of a TCI state associated with a control resource set (CORESET) pool index equal to 1; and using the DL RS as the PL RS.

Example 13 includes the method of example 9 or some other example herein, wherein the first cell is an additional cell that has at least one activated transmission configuration indicator (TCI) state, the second cell is a serving cell of the UE, and the method further comprises: identifying a downlink (DL) reference signal (RS) of a TCI state associated with a control resource set (CORESET) pool index equal to 0; and using the DL RS as the PL RS.

Example 14 includes the method of example 12 or 13 or some other example herein, wherein the DL RS is a channel state information-reference signal.

Example 15 includes a method to be implemented by a user equipment (UE), the method comprising: receiving, from a first cell, a physical downlink control channel (PDCCH) order to trigger a contention-free random-access (CFRA) physical random-access channel (PRACH) procedure toward a second cell; determining, based on the PDCCH order, a repetition number; and transmitting a random-access (RA) preamble one or more times based on the repetition number.

Example 16 includes the method of example 15 or some other example herein, wherein the PDCCH order comprises downlink control information (DCI) with a repetition number field to indicate the repetition number.

Example 17 includes the method of example 15 or some other example herein, further comprising: determining, based on decoding the PDDCH order, a control channel element (CCE) aggregation level; determining an association between the CCE aggregation level and the repetition number; and determining the repetition number based on the association.

Example 18 includes a method to be implemented by a network node, the method comprising: transmitting a first physical downlink control channel (PDCCH) order to cause a user equipment (UE) to perform a first physical random-access channel (PRACH) procedure toward an additional cell; obtaining a first timing advance (TA) value from the additional cell based on the first PRACH procedure; receiving, from the additional cell or the UE, a signal; and transmitting, to the UE based on the signal, a second PDCCH order to cause the UE to perform a second PRACH procedure toward the additional cell; and obtaining a second TA value from the additional cell.

Example 19 includes the method of example 18 or some other example herein, wherein the signal is received from the additional cell and includes an indication that a time-alignment timer has expired.

Example 20 includes the method of example 18 or some other example herein, wherein the signal is received from the additional cell and includes the first TA value and a time-alignment timer (TAT) configuration and the method further comprises: starting a TAT based on receiving the TAT configuration; and transmitting the second PDCCH order based on an expiration of the TAT.

Example 21 includes a method of example 18 or some other example herein, further comprising: receiving, from the additional cell, a time-alignment timer (TAT) configuration; transmitting, to the UE, the TAT configuration; and receiving the signal from the UE, wherein the signal includes an indication that the TAT has expired.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of aspects to the precise form disclosed. Modifications and variations are possible in light of the above teachings or may be acquired from practice of various aspects.

Although the aspects above have been described in considerable detail, numerous variations and modifications will become apparent to those skilled in the art once the above disclosure is fully appreciated. It is intended that the following claims be interpreted to embrace all such variations and modifications.

1.-21. (canceled)

22. A method of wireless communication, the method comprising:
obtaining a first timing advance (TA) value associated with a first transmit-receive point (TRP) of a serving cell;
receiving, from the serving cell, configuration information to configure a first group of resources associated with the first TRP and a second group of resources associated with a second TRP; and
obtaining a second TA value associated with the second TRP using a resource from the second group of resources.

23. The method of claim 22, wherein the first group of resources comprises a first synchronization signal block (SSB) and the second group of resources comprises a second SSB.

24. The method of claim 23, the method further comprises:
selecting the second SSB as the resource for obtaining the second TA value based on the first SSB being associated with an active transmission configuration indicator (TCI) state; and
selecting a physical random access channel (PRACH) resource associated with the second SSB; and
obtaining the second TA value by performing an intra-cell contention-based random-access (CBRA) procedure using the PRACH resource.

25. The method of claim 24, wherein the second group of resources comprises a plurality of SSBs and the method further comprises:
determining reference signal receive power (RSRP) values associated with the plurality of SSBs; and
selecting the second SSB as the resource for obtaining the second TA value based on the RSRP values.

26. The method of claim 22, wherein the first group of resources comprises a first random-access preamble and the second group of resources comprises a second random-access preamble.

27. The method of claim 22, wherein the configuration information is to configure a plurality of random-access (RA) preambles, the configuration information includes a group-size parameter, and the method further comprises:
determining, based on the group-size parameter, the first group of resources includes one or more first RA preambles of the plurality of RA preambles and the second group of resources includes one or more second RA preambles of the plurality of RA preambles.

28. The method of claim 27, further comprising:
receiving, from the serving cell, an indication of the second group of resources;
selecting the resource from the second group of resources based on the indication; and
obtaining the second TA value using the resource based on said selecting the resource.

29. The method of claim 22, further comprising:
receiving the configuration information in a system information block (SIB) or in radio resource control (RRC) signaling.

30. An apparatus comprising:
interface circuitry; and
processing circuitry coupled with the interface circuitry, the processing circuitry to:
receive, from a first cell via the interface circuitry, a physical downlink control channel (PDCCH) order to trigger a contention-free random-access (CFRA) physical random-access channel (PRACH) procedure toward a second cell;
select, based on the PDCCH order, a pathloss (PL) reference signal (RS);
calculate a pathloss and spatial filter based on the PL RS; and
perform the CFRA PRACH procedure based on the pathloss and the spatial filter.

31. The apparatus of claim 30, wherein the PDCCH order comprises downlink control information that indicates a synchronization signal block (SSB) and the processing circuitry is further to:
use the SSB as the PL RS.

32. The apparatus of claim 31, wherein the first cell is a serving cell, the second cell is an additional cell that does not have an activated transmission configuration indicator (TCI) state, and the processing circuitry is further to:
determine the SSB was included in a layer 1—reference signal receive power (RSRP) report transmitted by the UE no greater than a threshold period of time before receiving the PDCCH order; and
use the SSB as the PL RS based on said determination.

33. The apparatus of claim 30, wherein the first cell is a serving cell of a user equipment (UE), the second cell is an additional cell that has at least one activated transmission configuration indicator (TCI) state, and the processing circuitry is further to:
identify a downlink (DL) reference signal (RS) of a TCI state associated with a control resource set (CORESET) pool index equal to 1; and
using the DL RS as the PL RS.

34. The apparatus of claim 30, wherein the first cell is an additional cell that has at least one activated transmission configuration indicator (TCI) state, the second cell is a serving cell of a user equipment (UE), and the processing circuitry is further to:
identify a downlink (DL) reference signal (RS) of a TCI state associated with a control resource set (CORESET) pool index equal to 0; and
use the DL RS as the PL RS.

35. The apparatus of claim 34, wherein the DL RS is a channel state information-reference signal.

36. A method comprising:
outputting, for transmission to a user equipment (UE), a first physical downlink control channel (PDCCH) order to cause the UE to perform a first physical random-access channel (PRACH) procedure toward an additional cell;
obtaining a first timing advance (TA) value from the additional cell based on the first PRACH procedure;
receiving, from the additional cell or the UE, a signal;
outputting, for transmission to the UE based on the signal, a second PDCCH order to cause the UE to perform a second PRACH procedure toward the additional cell; and
obtaining a second TA value from the additional cell.

37. The method of claim 36, wherein the signal is received from the additional cell and includes an indication that a time-alignment timer has expired.

38. The method of claim 36, wherein the signal is received from the additional cell and includes the first TA value and a time-alignment timer (TAT) configuration and the method further comprises:
starting a TAT based on receiving the TAT configuration.

39. The method of claim 38, further comprising:
outputting the second PDCCH order for transmission based on an expiration of the TAT.

40. The method of claim 36, further comprising:
receiving, from the additional cell, a time-alignment timer (TAT) configuration; and
outputting, for transmission to the UE, the TAT configuration.

41. The method of claim 40, further comprising:
receiving the signal from the UE, wherein the signal includes an indication that the TAT has expired.
